(19) United States
(12) Patent Application Publication
(10) Pub. No.: US 2015/0342210 A1
(43) Pub. Date: Dec. 3, 2015

(54) METABOLIC OIL COMPOSITION, SYSTEM AND METHOD OF USE

(71) Applicant: THE BODY LAB, LLC, Glastonbury, CT (US)

(72) Inventor: David ALLEVA, Glastonbury, CT (US)

(73) Assignee: THE BODY LAB, LLC, Glastonbury, CT (US)

(21) Appl. No.: 14/729,012

(22) Filed: Jun. 2, 2015

Related U.S. Application Data
(60) Provisional application No. 62/006,818, filed on Jun. 2, 2014.

(51) Int. Cl. A23D 9/007; A23L 1/302; A23L 1/30; A23L 1/303

(52) U.S. Cl. CPC A23D 9/007; A23L 1/303; A23L 1/302; A23L 1/3008; A23V 2002/00

(57) ABSTRACT

An oil composition product for use in providing improvement in the metabolic function of an individual. The oil composition product, system and method provides an oil blend with improved metabolic function to an individual's diet, a system and method monitoring of the individuals food intake with the food diary, and measuring the individuals metabolism with a metabolic analyzer integrated in the system. Changes in the individuals body composition are realized as the blend of oil composition product has the ability to increase a person's ability to burn more of their daily calories as fat, thereby increasing body fat loss and preserving lean muscle tissue, weight reduction and performance when part of a sensible diet and workout plan.

The present application claims priority to provisional patent application No. 62/006,818 filed Jun. 2, 2014 entitled Metabolic Oil Composition.

### FIELD OF THE INVENTION

The present invention relates to an oil product for consumption and, more particularly, an oil composition product for increasing the metabolic rate, improving athletic performance, and improving cardio-function thereby supporting the metabolic function.

### BACKGROUND OF THE INVENTION

Typical oil products for consumption are made from one type of oil. Oils high in polyunsaturated fats such as corn, soy, sunflower, and other seed oils can form harmful oxalates compounds called HNE (4-Hydroxynonenal) when they are heated and, later when the oil is taken up in the body, there can be damaging effects as possible causal agents of numerous diseases, such as, chronic inflammation, neurodegenerative diseases, adult respiratory distress syndrome, atherogenesis, diabetes and different types of cancer. Olive oils while low in polyunsaturated fats are a healthy oil product when used for cooking such as frying, searing, grilling, stir-frying or roasting. However, these oils including olive oils have a long consumption, digestion and/or absorption factor that tend to suppress the metabolic rate, which inhibits fat loss in individuals striving to shed unwanted weight. While healthy oils and blends of healthy oils are known, these oils and blends have not been crafted to maximize the metabolic affect in the body.

As a result, there is a long felt need for an oil blend that utilized improves fat burning in the body. Fats are needed as nutrition and a source of energy. An oil blend crafted to maximize the metabolic effect in the body will improve the healthy results a person may want to achieve by increasing the metabolism of fats as a source of energy. The present invention provides an oil blend product that improves the metabolism of fats for weight loss, athletic performance, cardio function and as a metabolic booster and or supporting the metabolic function.

### SUMMARY OF THE INVENTION

It is an object of the present invention to provide an oil composition crafted to maximize the metabolic affect in the body.

It is an object of the present invention to provide an oil composition that increases the fat burning and fat loss in the body.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “MCT” or “MCT Oil” refers to Medium Chain Triglycerides (MCT) that are fats and/or plant-based oils that are naturally found in coconut and palm kernel oil. MCT oils have a rapid absorption profile which means that the human body more easily and rapidly digests MCT fats than other types of fats, as they require lower amounts of enzymes and bile acids for intestinal absorption. MCT's are metabolized very quickly in the liver and function to encourage increase in energy expenditure while decreasing fat storage thereby supporting healthy weight and body composition.

As used herein the term “Liquid Coconut Oil” refers to a liquid, rather than semi-solid or solid coconut oil. Liquid Coconut Oil is a fat and/or plant-based oil that is used by the body to produce energy. Liquid Coconut Oil has a rapid absorption profile which means that the human body more easily and rapidly digests coconut oil than other types of fats, as liquid coconut oil requires lower amounts of enzymes and bile acids for intestinal absorption and is metabolized very quickly in the liver and function to encourage increase in energy expenditure while decreasing fat storage thereby supporting healthy weight and body composition.

As used herein the term “Linseed Oil” “Flax Oil” or “Flaxseed Oil” refers to a food-grade, edible liquid fat and/or plant-based oil from flax plant (Linum usitatissimum, Linaceae)) seeds that is used by the body to produce energy. Flaxseed oil is a food product as it contains high levels of α-Linolenic acid (a particular form of omega-3 fatty acid). Flax seeds contain lignans, a class of phytoestrogens considered to have antioxidant and cancer preventing properties.

As used herein the term “DHA” refers to a food-grade, edible liquid fatty acid obtained directly from fish oil, milk or plants (micro-algae). DHA can be synthesized from alpha-linolenic acid (Docosahexaenoic acid (DHA)) and is an omega-3 fatty acid that is a primary structural component of the human brain, cerebrial cortes, skin, sperm, testicles and retina. DHA is useful for maintaining healthy cellular structure in the human body, e.g. brain, cerebrial cortes, skin, sperm, testicles and retina as well as increasing the cardio function of the body.

As used herein the term “Conjugated Linoleic Acid” “CLA” refers to a family of at least 28 isomers of linoleic acid found mostly in meat and dairy products derived from ruminants. CLA's can be either cis- or trans-fats and the double bonds of CLAs are conjugated and separated by a single bond between them. CLAs are utilized to increasing the athletic function of the body.

As used herein the term “Vitamin E” refers to a group of 8 fat-soluble compounds that include both tocopherols and tocotrienols. Vitamin E can be utilized to as a preservative for the oil blend at room temperature.

As used herein the term “Fat Soluble Vitamin” refers to a group of fat-soluble compounds that support the cellular structure and include Vitamin A, Vitamin D, Vitamin E and Vitamin K. Fat Soluble Vitamins can be utilized as a supplement for an oil blend to support the cellular structure of human cells.

As used herein the term “Macadamia Oil” refers to a liquid fat and/or plant-based oil from Macadamia oil (or macadamia nut oil) is the non-volatile oil expressed from the nut meat of the macadamia (Macadamia integrifolia) tree, a native Australian nut. Macadamia oil contains approximately 60% oleic acid, 19% palmitoleic acid, 1-3% linoleic acid and 1-2% α-linolenic acid. Some varieties contain roughly equal omega-6 and omega-3. The oil displays chemical properties typical of a vegetable triglyceride oil.

As used herein the term “Safflower Oil” refers to a liquid fat and/or plant-based oil from Safflower (Carthamus tinctorius L.) is a highly branched, herbaceous, thistle-like annual plant. It is commercially cultivated for vegetable oil extracted from the seeds that is used by the body to produce energy. Liquid Sunflower Oil has a medium absorption profile which means that the human body digests sunflower oil over a longer period of time than other rapid absorption types of fats. In dietary use, high-linoleic safflower oil has also been shown to increase adiponectin, a protein that helps regulate blood glucose levels and fatty-acid breakdown. Encourages increase in energy expenditure while decreasing fat storage thereby supporting healthy weight and body composition.

As used herein the term “Sunflower Oil” refers to a liquid fat and/or plant-based oil from sunflower (Helianthus annuus) seeds that is used by the body to produce energy. Sunflower oil is a polyunsaturated (PUFA)/monounsaturated (MULFA) mixture of mostly linoleic acid (omega-6) at %65, oleic acid at % 21(omega-9) the remainder saturated fat group of oils. The oil content of the see ranges from 22-36% (avg. 28%); the kernel contains 45-55% oil. Sunflower Oil has a medium absorption profile which means that the human body digests sunflower oil over a longer period of time than other rapid absorption types of fats.

As used herein the term “Walnut Oil” refers to a liquid fat and/or plant-based oil from English walnuts (also known as Persian walnuts) that is used by the body as a source of nutrition and to produce energy. Each 100.0 g of Walnut oil provides about 63.3 g polyunsaturated fatty acids, 22.8 g monounsaturated fats, and 9.1 g saturated fats. It contains no cholesterol. It is about 22.2% monounsaturated oleic acid, an omega-9 fatty acid, 52.9% linoleic acid, an essential polyunsaturated omega-6 fatty acid, and 10.4% alpha linolenic acid, Walnut Oil has a medium to slow absorption profile which means that the human body digests sunflower oil over a longer period of time than other rapid absorption types of fats. Walnut Oil supports an increase in metabolism as the faster absorbing oils are wearing off.

As used herein the term “Omega 7” (palmitoleic acid) refers to a food-grade, edible liquid monosaturated fatty acid obtained from fish oil. Palmitoleic acid is identified as a unique lipokine—a hormone-like molecule that links distant body tissues to assure optimal energy utilization and storage. Palmitoleic acid functions as a signaling molecule that facilitates communication between fat and muscle tissue in your body.

According to an embodiment of the present invention, a food product for improving the metabolic function, cardio function and athletic performance of a user, person and/individual is disclosed. The food product comprises an oil composition with varying predetermined amounts of specific oils having each of the Omega 3, 6 and 9 fatty acids. According to the present invention, the food product comprises a ratio of these varying fatty acids for increasing the metabolic rate, improving athletic performance, and improving cardio-function thereby supporting the metabolic function. The specific ratio throughout the description provides a formula for an oil composition product and is identified as a Product Composition.

According to an embodiment of the present invention, a Product Composition comprising essentially of an oil product blend is comprised of the following oils: MCT, liquid coconut, sunflower, safflower, flaxseed, Macadamia and Walnut oils. The Product Composition using these oils supply the user's body with fat and, as fats are sources of fatty acids classified in groups referred to as: Omega 3, 6 and 9 fatty acids, each of these oils contain varying amounts of each of the Omega 3, 6 and 9 fatty acids.

Accordingly, the present invention utilizes an innovative system to measure the individual's metabolic function, and a method use Product Composition(s) whereby is the ratio of these varying fatty acids comprise a predetermined formula for an oil composition product for useful in increasing naturally the metabolic rate, improving athletic performance, and improving cardio-function thereby supporting the metabolic function. A base part of the oil composition formula achieves an oil composition ratio of: 1-1.5 part Omega 3 to 1 part Omega 6. Additional embodiments the present invention achieve varying performance aspects by combining the base part mix of Omega 3 and 6 with a second part of the oil composition Omega 9 to a varying ratio depending on product/application as follows:

1 part (Omega 3 and 6) to 1-4 parts Omega 9. Where 1 part (Omega 3 and 6) to 4 parts Omega 9 being an optimal ratio. For example, a base part of the oil composition having a formula of

a) between about 15% and about 80% by weight based upon the weight of the entire composition of MCT Oil;

b) between about 15% and about 40% by weight based upon the weight of the entire composition of Liquid Coconut Oil;

c) between about 15% and about 30% by weight based upon the weight of the entire composition of Sunflower Oil; and

d) between about 15% and about 30% by weight based upon the weight of the entire composition of Flax Oil.

For example, a second part of the oil composition are has a formula of additional oils:

e) between about 10-25% by weight based upon the weight of the entire composition of Safflower Oil;

f) between about 4 and about 15% by weight based upon the weight of the entire composition of Macadamia nut Oil

g) about 5-15% by weight based upon the weight of the entire composition of Walnut oil

Furthermore, other additional parts of the oil composition may be formed with additional fatty acids

e) about 7.14% by weight based upon the weight of the entire composition of CLA and

f) about 1.78% by weight based upon the weight of the entire composition of DHA

g) less than 1% by weight based upon the weight of the entire composition of Omega 7(Palmitoleic acid)

Furthermore, other additional parts of the oil composition may be formed with vitamins

a) Up to 100% daily allowance of vitamins A, D, E, K, as is set forth herein.

According to an embodiment of the present invention, a food product for improving the metabolic function of a user is disclosed. A metabolic oil composition for a product may be formed in a Product Composition A. The present invention provides a food product composition comprising essentially of:

a) a base oil of between about 15% and about 80% by weight based upon the weight of the entire composition of MCT Oil; plus

b) between about 15% and about 40% by weight based upon the weight of the entire composition of Liquid Coconut Oil;

c) between about 15% and about 30% by weight based upon the weight of the entire composition of Sunflower Oil;

Product Composition A.

In an alternative embodiment of Product Composition A, herein Product Composition A₂, the present invention provides a food product composition comprising essentially of:

a) a base oil of between about 15% and about 80% by weight based upon the weight of the entire composition of MCT Oil; plus

d) between about 5% and about 30% by weight based upon the weight of the entire composition of Safflower Oil;

e) between about 15% and about 30% by weight based upon the weight of the entire composition of Flax Oil; and

f) between about 4% and about 15% by weight based upon the weight of the entire composition of Macadamia Oil.

Product Composition A₂

According to an alternative embodiment of the present invention, the base oil may be formed with up to 7.14% CLA. According to yet another alternative embodiment of the present invention, the base oil may be formed with up to 1.78% DHA. Each of the above identified Product Composition A and Product Composition Aₗ is formulated to ease digestion of oils in the body so as to maintain the metabolic rate of the person.

In yet another embodiment of the present invention, a metabolic oil composition for a product may be formed in a Product Composition A₃. A food product for improving the metabolic function may be formed in a food product composition comprising essentially of:

a) a base oil of about 22.2% by weight based upon the weight of the entire composition of MCT Oil;

b) about 22.2% by weight based upon the weight of the entire composition of Liquid Coconut Oil;

c) about 20.0% by weight based upon the weight of the entire composition of Sunflower Oil; and

d) about 7.7% by weight based upon the weight of the entire composition of Safflower Oil;

Product Composition A₃

According to an alternative embodiment of the present invention, Product Composition A₄, the substituting oils e) and f), below, for c) and d)

a) a base oil of about 22.2% by weight based upon the weight of the entire composition of MCT Oil;

b) about 22.2% by weight based upon the weight of the entire composition of Liquid Coconut Oil; plus

e) about 27.7% by weight based upon the weight of the entire composition of Flax Oil.

f) about 4.4% by weight based upon the weight of the entire composition of Macadamia nut Oil

Product Composition A₄

Each of the above identified Compositions A, A₂, A₃ and A₄ is formulated to ease digestion of oils in the body so as to maintain the metabolic rate of the person. Accordingly, the present invention may form oil blend product with Metabolic Support function as shown in the Product Compositions A, A₂, A₃ and A₄. As discussed herein, in conjunction with the oil Product Compositions A, A₂, A₃ and A₄, a system was designed to monitor a person's food intake with eating the oil to how it effects a person's body composition. Utilizing the food composition of the present invention along with an exercise program measurably increases and maintains the person's metabolic rate over a predetermined time period.

The present invention provides a food product composition for increasing the cardio-function hereinafter referred to as Product Composition B. Product Composition B comprising essentially of:

a) between about 15% and about 25% by weight based upon the weight of the entire composition of MCT Oil;

b) between about 15% and about 80% by weight based upon the weight of the entire composition of Liquid Coconut Oil;

c) between about 20% and about 30% by weight based upon the weight of the entire composition of Sunflower Oil; and

d) between about 20% and about 40% by weight based upon the weight of the entire composition of Flax Oil.

Product Composition B

In an alternative embodiment of Product Composition B, herein Product Composition B₂, the present invention provides a food product composition the base oil may be formed by adding e) essentially of:

e) up to 7.14% by weight based upon the weight of the entire composition of CLA Product Composition B₂

In an alternative embodiment of Product Composition B, herein Product Composition B₃, the present invention provides a food product composition the base oil may be combined with f) essentially of:

f) up to 10% by weight based upon the weight of the entire composition of Macadamia nut oil.

Product Composition B₃

In an alternative embodiment of Product Composition B, herein Product Composition B₄, the present invention provides a food product composition the base oil may be combined with g) essentially of:

g) up to 1.78% by weight based upon the weight of the entire composition of DHA

Product Composition B₄

In an alternative embodiment of Product Composition B, herein Product Composition B₄, the present invention provides a food product composition the base oil may be combined with h) essentially of:

h) about 5% by weight based upon the weight of the entire composition of Safflower Oil

Product Composition B₅

Accordingly, the present invention may form oil blend product with Metabolic Support and a specific Cardio Support function as shown in the Product Composition B, B₂, B₃, B₄ and B₅

For example, a specific formulation for improving the metabolic function may be formed in a food product composition to enhance the cardio function comprising essentially of:

a) about 10% by weight based upon the weight of the entire composition of MCT Oil;

b) about 44% by weight based upon the weight of the entire composition of Liquid Coconut Oil;

c) about 5% by weight based upon the weight of the entire composition of Sunflower Oil;

d) about 30% by weight based upon the weight of the entire composition of Flax Oil;

Product Composition B and

e) about 0.22% by weight based upon the weight of the entire composition of CLA Product Composition B₂

f) about 1.78% by weight based upon the weight of the entire composition of DHA Product Composition B₃

g) about 4% by weight based upon the weight of the entire composition of Macadamia nut oil; Product Composition B₄

h) about 5% by weight based upon the weight of the entire composition of Safflower Oil; Product Composition B₅

Each of the above identified Product Composition B, B₂, B₃, B₄ and B₅ is formulated to ease digestion of oils in the body so as to maintain the metabolic rate of the person. Accordingly, the present invention may form oil blend product with Metabolic Support function as shown in the Product Composition B, B₂, B₃, B₄ and B₅. As discussed herein, in conjunction with the oil Product Composition B, B₂, B₃, B₄ and B₅, a system was designed to monitor a person's food intake with eating the oil to how it effects a person's body composition. Utilizing the food composition of the present invention along with an exercise program measurably increases and maintains the person's to enhance the “Cardio” function and metabolic rate over a predetermined time period.

According to an embodiment of the present invention, a food product for improving the metabolic function and “athletic performance” function of a user is disclosed. A metabolic oil composition for a product may be formed in a Product Composition C. The present invention provides a food product composition for increasing athletic performance comprising essentially of:

a) between about 15% and about 80% by weight based upon the weight of the entire composition of MCT Oil;

b) between about 15% and about 40% by weight based upon the weight of the entire composition of Liquid Coconut Oil;

c) between about 15% and about 30% by weight based upon the weight of the entire composition of Sunflower Oil; and

d) between about 15% and about 30% by weight based upon the weight of the entire composition of Flax Oil.

e) between about 10-25% by weight based upon the weight of the entire composition of Safflower Oil;

f) between about 4 and about 15% by weight based upon the weight of the entire composition of Macadamia nut Oil

Product Composition C

In an alternative embodiment of Product Composition C, herein Product Composition C₂, the present invention provides a food product composition the base oil may be combined with e) essentially of:

e) up to 7.14% by weight based upon the weight of the entire composition of CLA Product Composition C₂

In an alternative embodiment of Product Composition C, herein Product Composition C₃, the present invention provides a food product composition the base oil and e) of Product Composition C _{email 2} may be combined with f) consisting essentially of:

f) up to 1.78% by weight based upon the weight of the entire composition of DHA Product Composition C₃

Each of the above identified Product Composition(s) C, C₂, and C₃ is formulated to ease digestion of oils in the body so as to maintain the metabolic rate to enhance the “athletic performance” function of the person. Accordingly, the present invention may form oil blend product with Metabolic Support function as shown in the Product Composition(s) C, C₂, and C₃. As discussed herein, in conjunction with the oil Product Composition(s) C, C₂, and C₃ a system was designed to monitor a person's food intake with eating the oil to how it affects a person's body composition. Utilizing the food composition of the present invention along with an exercise program measurably increases and maintains the person's to enhance the “athletic performance” function and metabolic rate over a predetermined time period.

According to an embodiment of the present invention, a specific formulation for improving the metabolic function may be formed in a food product composition to improve the athletic performance of an individual is disclosed. A metabolic oil composition for a product may be described in a Product Composition D. The present invention provides a food product composition for increasing and improving the athletic performance of an individual comprising essentially of:

a) about 24.5% by weight based upon the weight of the entire composition of MCT Oil;

b) about 20.5% by weight based upon the weight of the entire composition of Liquid Coconut Oil;

c) about 20% by weight based upon the weight of the entire composition of Sunflower Oil;

d) about 15.08% by weight based upon the weight of the entire composition of Flax Oil;

e) about 7.14% by weight based upon the weight of the entire composition of CLA and

f) about 1.78% by weight based upon the weight of the entire composition of DHA

g) about 4% by weight based upon the weight of the entire composition of Macadamia nut oil

h) about 5% by weight based upon the weight of the entire composition of Safflower Oil;

Product Composition D

According to an embodiment of the present invention, a specific formulation Product Composition D₂ for improving the metabolic function may be formed in a food product composition to improve the athletic performance of an individual is disclosed. A metabolic oil composition for a product may be described in a Product Composition D₂. The present invention provides a food product composition for increasing and improving the athletic performance of an individual comprising essentially of:

a) about 24.5% by weight based upon the weight of the entire composition of MCT Oil;

b) about 20.5% by weight based upon the weight of the entire composition of Liquid Coconut Oil;

c) about 14% by weight based upon the weight of the entire composition of

Sunflower Oil;

d) about 15.08% by weight based upon the weight of the entire composition of Flax Oil;

e) about 7.14% by weight based upon the weight of the entire composition of CLA and

f) about 1.78% b by weight based upon the weight of the entire composition of DHA

g) less than 1% by weight based upon the weight of the entire composition of Omega 7 (Palmitoleic acid)

h) about 4% by weight based upon the weight of the entire composition of Macadamia nut oil

i) about 5% by weight based upon the weight of the entire composition of Safflower Oil;

j) about 8% by weight based upon the weight of the entire composition of Walnut oil Product Composition D₂

According to an embodiment of the present invention various supplements also may be blended with the base oil to accomplish several important bodily functions. For example, Vitamin E can be utilized in small amount in each of Product Compositions A, B, C and D as a natural preservative up to 100% of daily allowance per serving. Moreover, for example, Fat soluble Vitamins A, D, K can be utilized in small amount in each of Product Compositions A, B, and C (and Product Compositions A1, B1 and C1) as a cellular support up to 100% of daily allowance per serving.

According to an embodiment of the system, described herein, utilizing the oils of the present invention, a method of improving metabolism of fats, comprising the steps of:

determining the metabolic capacity of a human individual

computing a metabolic ratio for the human individual

using the metabolic ratio to choose an oil blend composition

Accordingly, an exemplary system for use in connection with Product Compositions A, B, C and D, an analyze configured to measure the individuals metabolic rate (MR) and respiratory quotient (RQ) may be used to determine which of the product compositions should be used by a particular individual so as to maintain the metabolic rate, improve the cardio function or the athletic function of the individual. In analyzing the RQ measurement, a determination may be made as to what fuel is being used by the individual at that time (fat, protein or carbohydrate) to produce. From the data of applicants experiments utilizing the system and method of the present invention, the data demonstrates that individuals may obtain fat loss, improved blood chemistry and better performance from exercise and food, are the people that can burn the most fat at rest and during exercise.

The oil in Product Compositions A, B, C and D along with other foods in the diet is logged in a food diary on a computer or mobile device into our system. The system then totals up the food consumed and tallies up the total amount of Protein, fats carbohydrate and calories of what was consumed. Example: 2,443 calories, 134 grams of protein, 193 grams of fat and 56 grams of carbohydrate. The next day the person is instructed to measure themselves on a scale that is capable of measuring weight and body fat percent (lean mass vs. fat mass) and also records weight and body fat results daily into our system. The person is then instructed to eat the same amount of food daily for a week and weigh themselves daily. This data is then collected into our system to look for trends by being displayed in graphs that plot out the weight, fat mass and muscle mass. By displaying the data a “user” is then capable of seeing how the food effects body composition. This information is then used to adjust the amount of Protein, fats carbohydrate and calories to achieve fat loss by preserving muscle mass.

In conjunction with the oil, a system was designed to monitor a person's food intake (with the oil) to how it effects a person's body composition. It is the overall approach of introducing the oil into the diet, monitoring food intake with the food diary measuring metabolism with the analyzer, change in body composition with a body fat scale and the input of all this data into our computer application software that stores and graphs this data that enables a user to see the changes in fat mass and muscle mass to adjust the amount and ratios of Protein, fats carbohydrate and calories to achieve fat loss and to maintain or increase muscle mass.

The system and method of the present invention works by reducing carbohydrate and increasing the oil blend to acheive a higher amount of fat being utilized as a fuel source. The system confirms the reduction of fat mass being measured by the scale and may be recorded in the system using the metabolic analyzer and software configured to measure these parameters. Moreover, once a reduction of fat mass can be measured the system can then adjust the protein intake to achieve the maintenance or increase in muscle mass.

Applicant has found that not all people burn fat at the same rate and that the system of the present invention may be utilized to determine what type of person's metabolism is present and craft an effective metabolic function therefrom. In order to increase a person's ability to burn fat, this oil blend was created. Based on the amount and type of fat in the diet, would result in an increase in a person's ability to burn fat. For example, experimentation data demonstrates that the various combinations of Product Compositions A, B, C and D provide a metabolic balance with the additional cardio or athletic performance desired.

Applicant recognizes that balance was achieved in Product Compositions A, B, C and D because each type of oil is consumed and burned by the metabolism of the body at different rates. For example, the base oil identified in a) tends to increase the overall fat burning of the individual; however, its effects are short lived as the body consumes these light oils. Subsequent oils, for example, oil identified in b) in Product Compositions A, B, C and D burns slower. Similarly, the next oil identified c) burns even slower by the body's metabolic function of the particular individual. As a result, applicant recognize that a desired metabolic function and effect may be created utilizing plans of varying digestion factors of the oils as identified in Product Compositions A, B, C and D so as to create the desired effect.

In general we have observed that this blend of oil has the ability to increase a person's ability to burn more of their daily calories as fat, thereby increasing body fat loss and preserving lean muscle tissue, weight reduction and performance when part of a sensible diet and workout plan. Simply, in effect, as one oil increases metabolic rate and burns out, the next slower burning oil kicks in and increases metabolism. Over a predetermined time period between meals of an individual, for example, oil identified as a) is fully consumed, then the oil identified as b) is fully consumed, then the oil identified as c) is fully consumed and so on so said the blend may be designed so that the desired effect is to burn through the entire fat calorie intake between meals.

As a result, an individual using the oil blend identified in Product Compositions A, B, C and D will burn through all the fats consumed before the next recommended eating, consumption or otherwise it notified serving cycle of the individual. This is repeated over the entire day, and days of the week, and weeks of the month, and over time the individual's metabolic rate wakes up and adapts and starts to burn fat more quickly, or by the individual experiences weight loss, improve cardio function and athletic performance as desired.

While certain configurations of structures have been illustrated for the purposes of presenting the basic structures of the present invention, one of ordinary skill in the art will appreciate that other variations are possible which would still fall within the scope of the appended claims. For example, Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents

Typical diet plans are based on the assumption that in order to lose weight, one must reduce calories and increase physical activity. The problem is most people lose fat and muscle because they do not consume the proper ratios of Protein, fat and carbohydrate. This system focuses on fat loss rather than weight loss and implements a comprehensive analysis of how to arrive at the proper amount and ratios of Protein, fat, carbohydrate and calories that is unique to the individual. This specific nutrient requirement for the individual leads to mostly fat loss as opposed to losing fat and muscle.

What is claimed is:

1. An oil composition product for use in providing improvement in the metabolic function of an individual comprising:
A. a base oil of between about 15% and about 80% by weight based upon the weight of the entire composition of MCT Oil;
B. between about 15% and about 40% by weight based upon the weight of the entire composition of Liquid Coconut Oil;
C. between about 15% and about 30% by weight based upon the weight of the entire composition of Sunflower Oil; and
D. between about 15% and about 30% by weight based upon the weight of the entire composition of Flax Oil.
whereby a highly efficient and effective food product that provides a metabolic balance as desired.

2. The oil composition product defined in claim 1, wherein said composition is further defined as comprising:
E. between about 10-25% by weight based upon the weight of the entire composition of Safflower Oil;
F. between about 4 and about 15% by weight based upon the weight of the entire composition of Macadamia nut Oil
G. about 5-15% by weight based upon the weight of the entire composition of Walnut oil.

3. The oil composition product defined in claim 2, wherein said composition is further defined as comprising:
H. up to 100% daily allowance of one or more of the vitamins from the group of vitamins A, D, E, K.

4. The oil composition product defined in claim 1, wherein said composition is further defined as comprising:
E. up to 7.14% by weight based upon the weight of the entire composition of CLA whereby a highly efficient and effective food product that provides improved cardio function as desired.

5. The oil composition product defined in claim 4, wherein said composition is further defined as comprising:
F. about 1.78% by weight based upon the weight of the entire composition of DHA
G. about 4% by weight based upon the weight of the entire composition of Macadamia nut oil
H. about 5% by weight based upon the weight of the entire composition of Safflower Oil;
whereby a highly efficient and effective food product that provides improved athletic performance as desired.
